(19) United States
(12) Patent Application Publication
(10) Pub. No.: US 2003/0014488 A1
(43) Pub. Date: Jan. 16, 2003

(54) System and method for enabling multimedia conferencing services on a real-time communications platform

(76) Inventors: Siddhartha Dalal, Bridgewater, NJ (US); Gardner Patton, Bridgewater, NJ (US); Hyong Sop Shim, Basking Ridge, NJ (US)

Correspondence Address: David A. Hey, Esq., Telcordia Technologies, Inc., 445 South Street, Room 1G112R, Morristown, NJ, 07960, US

(21) Appl. No.: 10/167,712

(22) Filed: Jun. 11, 2002

Related U.S. Application Data
(60) Provisional application No. 60/297,974, filed on Jun. 13, 2001.
(60) Provisional application No. 60/298,308, filed on Jun. 14, 2001.

(51) Int. Cl. G06F 15/16; H04Q 11/00; H04L 12/16

(52) U.S. Cl. 709/204; 370/260

(57) ABSTRACT

The present invention relates to the field of software systems, specifically in the area of Voice over IP, conferencing, instant messging and presence and availability management. In particular, the present invention provides a system and method for enabling multimedia, real-time group communications on real-time communications platforms. The present invention takes advantage of the properties available in real-time communications platforms to provide multimedia, real-time conferencing and communications services.

### CROSS-REFERENCE TO RELATED APPLICATIONS

This application claims the benefit of U.S. Provisional Application No. 60/297,974, filed Jun. 13, 2001 and of U.S. Provisional Application No. 60/298,308, filed Jun. 14, 2001, the contents of which are incorporated by reference.

### BACKGROUND OF THE INVENTION

The present invention relates to the field of software systems, specifically in the area of Voice over IP, conferencing, instant messaging, and presence and availability management.

In today's distributed team-oriented enterprise workspace, the ability to conduct multiparty conferencing anytime, anywhere, and on demand has become critical to increasing the productivity and effectiveness of group work. Team members may be geographically distributed or traveling and yet have a need to collaborate in real time in order to perform their tasks. In addition, group work is often highly interactive and spontaneous, resulting in the need for both regularly scheduled meetings and impromptu communications. Therefore, the ability of group members to communicate with each other in an efficient manner is critical to increasing the productivity of group work.

The widespread availability of networked multimedia computers, handheld communicators, and mobile phones greatly help co-workers keep in touch with each other, regardless of their geographical locations. However, without a third-party service, the communication is often limited to one-to-one. Multiparty conferencing systems are available for both PSTN and VoIP users; for example, H.323 Multipoint Control Units (MCUs), but usually require conferences to be scheduled in advance with enforced resource constraints; such as, the maximum number of participants and the duration of a conference. Hence, these systems cannot support spontaneous group communications in an efficient manner.

Meanwhile, networked computers are playing a critical and increasing role in the field of real time multimedia communications. For example, the widespread and increasing popularity of presence-based instant messaging applications, e.g., AOL IM, Yahoo Messenger, and MSN Messenger, exemplify how networked computers are changing the way people communicate and work with each other. To meet this increased demand, computer hardware and software manufacturers are rapidly increasing their support for real time multimedia communications. One popular approach is to provide a real time communications platform, which defines a communications model, provides “building-block” services for development of real-time multimedia communications services, and provides guidelines for establishing and managing real time communications channels in a networked computer environment. The guidelines are often provided in the form of an Application Programming Interface (API), which enables different third-party service providers to build their own applications and services.

The Microsoft Real-time Communications Client (MS RTC) platform is an example of such a platform. MS RTC provides protocol-level support for audio, video, and text-based instant messaging (IM) communications, which includes implementation of Real Time Protocol (RTP) and Real Time Control Protocol (RTCP) and Session Initiation Protocol (SIP). RTP and RTCP are the de-facto standard protocols for transporting real-time communications payloads, e.g., audio and video, in IP networks, and SIP is fast emerging as the industry standard for establishing communications sessions in IP and PSTN networks. MS RTC also implements T. 120, which is an industry standard protocol for application sharing, a collaboration paradigm that enables geographically distributed users to work together via their networked computers. In order to facilitate rapid development of real-time communications applications, MS RTC provides a high-level abstraction, called a session, which effectively hides the complexities involved in using these protocols. In MS RTC, a session represents two communicating end points. To create a session, application developers only need to specify the addresses of the end points, i.e., the IP address and port number, and indicate its communication type, e.g., audio, video, or IM. Given this information, MS RTC automatically performs protocol operations needed to establish the network connections between the end points and transport communications payloads “behind the scenes.”

Unfortunately, support for multimedia group (or multi-party) communications is not built in the MS RTC and other similar platforms. The default mode of communication is to use a point-to-point network connection between two communicating end points. Therefore, to allow multiparty communications, additional hardware/software components are required which can be built as an API to the MS RTC and similar platforms.

There are existing products, such as First Virtual Communications' Conference Server, that provide multimedia group communications services. However, these are standalone products that are not built using the MS RTC or similar platforms.

Therefore, there remains a need in for improvements in the field of multiparty communications, and particularly in providing multimedia, real-time group communications on the MS RTC and similar platforms.

### SUMMARY OF THE INVENTION

The present invention provides a system and method for enabling multimedia, real-time group communications on the MS RTC and other similar platforms. In particular, the present invention takes advantage of the properties available in the MS RTC and other similar platforms to provide multimedia, real-time conferencing and communications services.

### BRIEF DESCRIPTION OF THE DRAWINGS

FIG. 1 shows the architectural overview according to one embodiment of the present method, in which the clients in a conference are communicating via central media servers and each client is connected to the media server by establishing a real-time session with the server. The session is established via the real-time communications (RTC) platform, on which the client application is built.

FIG. 2 shows a conference control protocol for creating, inviting users to, joining, leaving, and un-inviting participants from conferences, according to another embodiment of the present invention. This protocol describes the functional behaviors of the conference control components shown in FIG. 1, namely CCC and SPCC, when performing conference control tasks.

FIG. 3 shows a method by which a telephone or telephones can be used to participate in multiparty conferences, and represents an expanded view of the PSTN box shown in FIG. 1.

FIG. 4 shows the architecture of the client application according to a further embodiment of the present method, in which the conference controller component of the client application (CCC) is implemented as an instant messaging (IM) session established with the conference controller component of the conference service provider (SPCC). This IM session is established via the RTC platform, on which the client application is built.

FIG. 5 shows the architectural overview according to another embodiment of the present method, in which the CCC is implemented as the Web browser application connected to the Web server of the conference service provider, which functions as the SPCC.

FIG. 6 shows an XML schema illustrating the schema that would be used in a Web Services embodiment of the present method.

FIG. 7 shows an “instance document” illustrating the XML that would be used in a Web Services embodiment of the present method.

### DETAILED DESCRIPTION OF THE INVENTION

The present invention describes a method for enabling multimedia group communications services using the communications services in the MS RTC platform. The present invention also applies to enabling multimedia group communications services on other platforms with properties similar to those of the MS RTC. Throughout the description of the present invention, the term “MS RTC” shall mean the Microsoft Real-time Communications Client platform, while “RTC” will be used to generically represent the MS RTC and other similar platforms. Further, the term, “conference”, means group (or multi-party) communications, while “multimedia conference” means that conference participants communicate by exchanging communications payloads of multiple media types. Moreover, when referring to a “conference” in describing the present invention, unless otherwise stated, a “multimedia conference” is intended. In addition, the phrase “conference media type” means a communication media type to be used in a conference and its bandwidth and other QoS requirements associated with the media.

The present invention makes novel use of the concept of a session, which is a common platform property in RTC platforms. As described earlier, a session represents two communicating end points. The session may have a number of streams, each of which represents a communications channel. Each stream is associated with a specific media type, e.g., audio or video, and transports the communications payloads of its media type to and from the communicating end points. A stream is characterized as either real-time or non real-time depending on the delivery requirements of the communications payloads that it transports. In the MS RTC platform, real-time media is known as streaming media. A real-time stream transports media payloads that should be delivered with minimum communications latency, i.e., as soon as possible, to be useful for the receiving end point. Audio and video are examples of media payloads with real-time delivery requirements. A non real-time stream transports media payloads without strict real-time delivery requirements. E-mail is an example of a media payload with non real-time delivery requirements. Text instant messages (IM) are generally regarded as non real-time media payloads in the industry, although the end user experience may indicate otherwise and may sometimes be treated in the RTC platforms as real-time media payloads.

A session with real-time streams is called a real-time session. A session with non real-time streams is called a non-real-time session. Typically, RTC platforms do not allow non-real-time streams in real-time sessions, nor real-time streams in non-real-time sessions. For example, the MS RTC platform does not allow text instant message communications in the same session with audio/video. As will be described in detail below, the present invention for enabling conferencing services on the RTC platforms applies regardless of this restriction.

Typically, RTC platforms do not allow users to have multiple real-time sessions at the same time, but do allow users to participate in multiple, simultaneous, non-real time sessions, or in a single real-time session while simultaneously participating in multiple, different, non-real-time sessions. For example, the MS RTC platform allows users to have multiple instant messaging sessions along with one audio/video session. However, it does not support multiple audio/video sessions at the same time. This restriction on use is consistent with the general assumption that users do not participate in multiple audio/video communications at the same time. The present invention describes a method for enabling multimedia conferencing services on the RTC platforms that have this limitation, but applies equally to the RTC platforms that do not have this limitation.

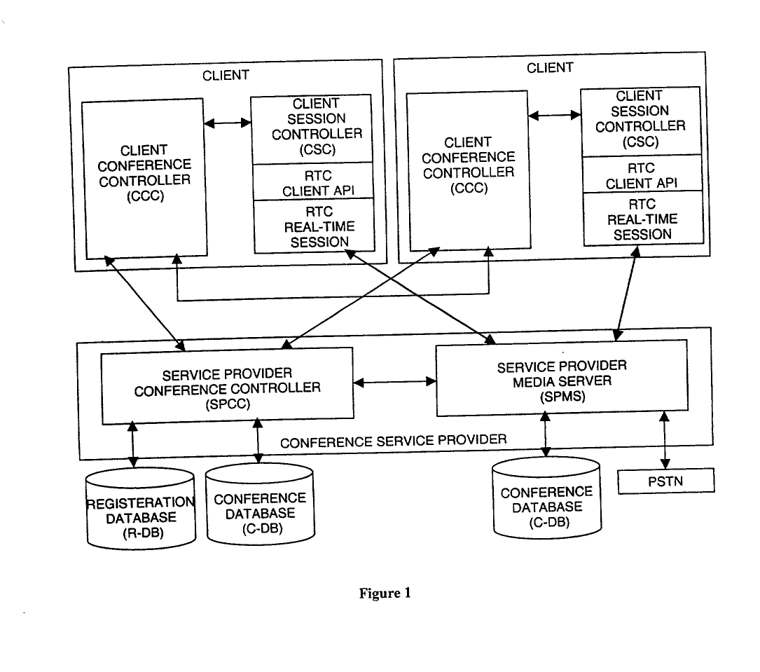

FIG. 1 shows the architectural overview of one method for enabling multimedia, real-time conferencing services on the RTC platform according to one embodiment of the present invention. The architecture is client-server and assumes IP-based networks. In FIG. 1, CONFERENCE SERVICE PROVIDER refers to the service provider who controls server components in the system, i.e., SERVICE PROVIDER CONFERENCE CONTROLLER (SPCC) and SERVICE PROVIDER MEDIA SERVER (SPMS). SPCC is mainly responsible for performing administrative tasks related to conference management. SPMS is mainly responsible for handling communications payloads for ongoing conferences. Specifically, each conference is associated with an SPMS, and each conference participant establishes a real-time session with the SPMS. Then the participants first send their media payloads to the SPMS, which then routes them to the rest of the participants. The SPMS may also “mix” received media streams before sending them to the conference participants.

In FIG. 1, CLIENT refers to an application process through which the end user uses the service of the conference service provider. Architecturally, it consists of CLIENT CONFERENCE CONTROLLER (CCC) and CLIENT SESSION CONTROLLER (CSC). Along with SPCC, CCC is responsible for performing administrative tasks related to conference management. CSC is the client-side component that is directly built on the real-time communications services of the underlying RTC platform. Specifically, CSC establishes a real-time session using the API provided by the RTC platform in order to connect to the conference SPMS.

In addition to the CCC and CSC, the CLIENT may include communications devices that are associated with specific media types and capable of generating and rendering the communications payloads of the associated media types. In a preferred embodiment of the present invention, the CLIENT may be built on the API of the MS RTC platform, and the communications devices may make use of the audio, video, and IM communications capabilities in the MS RTC platform.

The key feature that makes the described architecture well suited for providing a multimedia, real-time conferencing service on RTC platforms is use of an RTC real-time session with a central media server, namely SPMS, for the purpose of routing the communications payloads between conference participant CLIENTs. As discussed previously, RTC platforms only allow a single real-time session at a time which means that any conferencing architecture that allows participant clients to have multiple and simultaneous real-time sessions cannot be supported on these RTC platforms. Examples of such conferencing architectures include a full-mesh architecture, in which a participant client can communicate with all the other participant clients in a conference, and a hierarchical architecture, in which one or more participant clients can mediate multiple streams of communications payloads to and from the other participant clients. By delegating the task of routing the communications payloads between participant clients to a central server, the architecture of the present invention as shown in FIG. 1 effectively allows a single, real-time session to be used for multi-party communications. The architecture of the present invention is general in that it can also be used to provide a multimedia, real-time conferencing service, even when the underlying RTC platform may or may not support multiple, simultaneous real-time sessions.

The functional operations of the major architectural components shown in FIG. 1: CCC, CSC, SPCC, and SPMS will be described in more detail below, particularly with respect to how these components perform conference management tasks. Multimedia, real-time conferencing systems perform many conference management tasks, including, but not limited to: create a conference, delete a conference, invite (or add) a participant to a conference, leave a conference, remove a participant from a conference, add a media stream to a conference, and remove a media stream from a conference. The following functional descriptions relate to specific embodiments of the present invention for implementing the CCC, CSC, SPCC, and SPMS, but the present invention is not limited to such embodiments but rather covers various implementations. For example, CCC and CSC may be implemented as separate objects communicating with each other via means of object method invocation in an object-oriented embodiment of the CLIENT, but may also be implemented in a procedural manner in a single software module in another embodiment. Further, in one embodiment of the present invention, the system may have multiple instances of the SPCC and SPMS, which run on different computers that are interconnected via IP networks in order to enhance scalability, availability, fault tolerance, load balancing and other performance-related system properties. However, in another embodiment, the SPCC and SPMS may be implemented as a single software module that runs on a single computer.

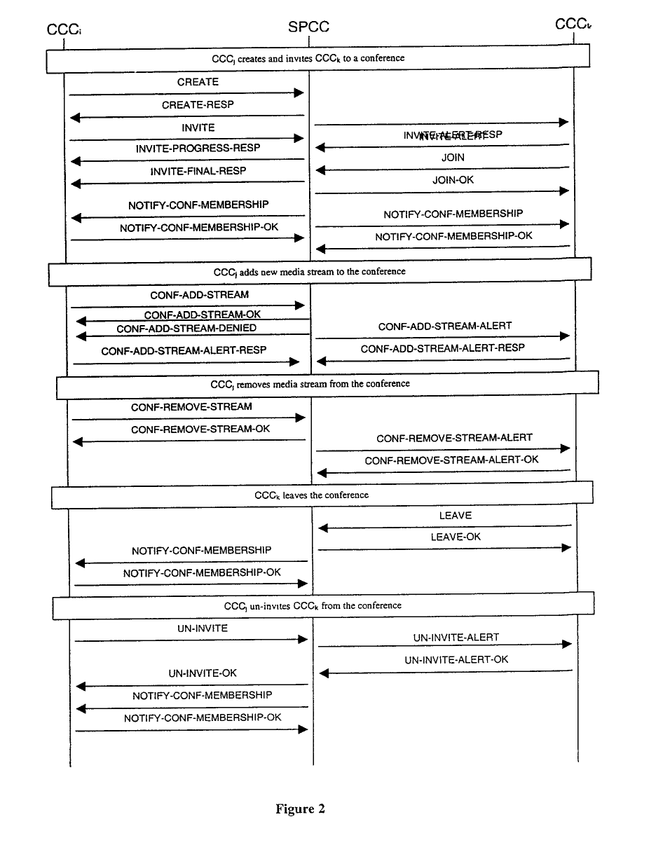

FIG. 2 gives an overview of how CCC and SPCC perform their conference management tasks in terms of protocol messages they execute together, in accordance with one embodiment of the present invention. FIG. 2 does not show CSC and SPMS, as their behaviors are highly dependent on the way the real-time session and communications support is provided in the underlying RTC platform. Rather, the behaviors of CSC and SPMS will be more fully described in connection with a preferred embodiment of the present invention that uses the MS RTC. FIG. 2 shows only the request-response interactions between the “client,” i.e., CCC, and “server,” i.e., SPCC, although other interactions occur between the CCC and CSC and between the SPCC and SPMS as a result of processing the request and response messages in FIG. 2.

To send a request or a response requires the destination address, i.e., the IP address and port number of the destination host. Thus in the preferred embodiment of the present invention, a request is always sent to a known destination and contains the address to which the corresponding response should be sent. In the following description of request-response interactions, it is assumed that a request contains the response address as part of the information it carries.

Creating a Conference

To create a new conference, the CCC of a CLIENT sends a CREATE request to the SPCC. This request includes the identification information (UID) of the user who wishes to create the conference. The UID uniquely identifies a valid user in the system and may be used to locate the user. In a preferred embodiment of the present invention, the UID is in the form of a URL, e.g., jsmith@company.com. Furthermore, all users are required to register with the system before they can use the conference services of the system, wherein the registration process collects user address information of their host computer, such as, the IP address and port number, from which the user is accessing the system. The system stores this information, along with the UID of the user in its Registration Database (R-DB).

In addition to the UID of the conference creator, the CREATE request may include the conference media type information. Specifically, it may contain a list of media tuples, (MEDIA, CODEC, QoS), where MEDIA specifies a media type, e.g., audio and video, CODEC is a codec to be used for encoding and decoding media payloads of the specified type, e.g., G711, and QoS specifies the desired bandwidth and other QoS properties. This list is collectively called a conference media type.

Semantically, the conference media type in the CREATE request specifies the media types preferred by the conference creator. The media types that are initially allowed or supported by the SPCC and SPMS are specified in the conference media type in the INVITE-ALERT request that the SPCC sends to the CCC of the CLIENT of an invited user. The media tuples in the supported conference media type are a subset of the media tuples in the corresponding preferred conference media type.

In the preferred embodiment of the present invention that uses the MS RTC platform, the media tuples in a preferred or supported conference media type need only specify the MEDIA value. This is due to the fact that the MS RTC platform does not currently allow applications to specify or control the codec and QoS properties of real-time media communications.

Note that no two media tuples in the same conference media type may have the same values for MEDIA, CODEC, and QoS. However, the media tuples may have the same MEDIA value. Defining the exact semantics of such media tuples is beyond the scope of the present invention. In the preferred embodiment of the present invention, the SPCC may only allow a single media tuple of a particular MEDIA value in its supported conference media type.

In addition to the UID of the conference creator and preferred conference media type, the CREATE request may further include conference metadata, e.g., conference name, conference purpose, conference start and end time, and name of the conference creator. If the conference start and end time information is not present in the CREATE request, the new conference is set up to commence as soon as possible.

Upon receiving the CREATE request, the SPCC checks whether or not the request is sent by an authorized user. In the preferred embodiment of the present invention, the CREATE request may have security information that allows the SPCC to authenticate the request sender. To create a new conference, SPCC generates a conference identifier (CID), which uniquely identifies the conference in the system and also creates a conference database record and stores in it the CID of the conference, along with its creator UID, the preferred conference media type, and any metadata in the CREATE request. The SPCC then saves the conference database record in its Conference Database (C-DB). Furthermore, the SPCC may create a supported conference media type for the conference. The contents of the supported conference media type may depend on a number of variables, which may include, but are not limited to, available network bandwidth, the current load on the SPMS, and the capability of the service provider to support a particular media type. Once created, the supported conference media type is stored in the conference database record. In one embodiment of the present invention that has multiple instances of the SPMS, the SPCC may create the supported conference media type when it selects a particular SPMS instance to use for the conference, i.e., when processing JOIN requests.

Subsequently, the SPCC sends the CID of the conference in a CREATE-RESP response to the CCC of the CLIENT that sent the CREATE request. This response may also include, but is not limited to, the supported conference media type, if it is created.

In the preferred embodiment of the present invention that may have multiple instances of the SPCC, the CCC of the CLIENT is associated with a particular instance of the SPCC at the registration, or system “login” time. For example, as part of the registration process, the CCC learns the address information of the SPCC, i.e., the IP address of the host computer of the SPCC and the port number at which the SPCC listens for incoming requests.

Deleting a Conference

To delete a previously created conference, the CCC of a CLIENT sends a DELETE request to the SPCC (not shown in FIG. 2). This request includes the UID of the user who wishes to delete the conference and the CID of the conference to be deleted. Upon receiving the DELETE request, the SPCC checks whether or not the request is sent by a user who is authorized to delete a conference, and if so, finds the conference database record for the appropriate CID in the C-DB and then deletes that conference database record. It also alerts the SPMS, which releases its resources for the conference. If the conference has participants, the SPCC may send an UN-INVITE-ALERT request to the CCC of each of the participant CLIENT. The processing of UN-INVITE-ALERT is described in more detail below. Subsequently, the SPCC sends a DELETE-RESP response to the CCC of the CLIENT that sent the DELETE request.

In one embodiment of the present invention, the SPCC may have a policy to automatically delete a conference once all the participants have left which allows the SPMS may free up its resources when all the participants have left and dynamically allocate new resources when participants newly join the conference at a later time. In another embodiment, the SPCC may have a policy not to delete a conference until it receives a DELETE request, in which case, the SPCC maintains its conference database record until it receives a DELETE request. The present invention also includes an embodiment where both policies are supported and users are allowed to choose which policy to enforce on a per conference basis.

Inviting a Participant to a Conference

To invite a user to a conference, the CCC of a CLIENT sends an INVITE request to the SPCC. Prior to sending this request, the CCC has the CID of the conference, i.e. the CREATE conference process has already occurred.

In addition to the CID, the INVITE request includes the address information of the invited participant. This address information includes the UID of the user to be invited, the IP address/port number of a computer, or a PSTN phone number and may include other pertinent information, such as the UID of the inviting user. When the UID is specified, the SPCC finds the current location of the invited user by looking up the user's registration record in its R-DB.

The user may invite him-self to the conference by specifying his own UID in the INVITE request. In one embodiment of the present invention, the processing of such INVITE requests is identical to that of the “usual” INVITE requests that invite other users. In a different embodiment of the present invention, the functionality of the self-INVITE request may be subsumed by the CREATE request by having the user who creates a conference automatically join the conference.

Upon receiving an INVITE request with a UID as the destination address of the invited, the SPCC retrieves the CID and destination address information from the request. SPCC then retrieves from its C-DB the conference database record with the matching CID. If no such record is found, the SPCC sends an INVALID response to the requestor. Otherwise, SPCC retrieves from its R-DB the registration record with the UID that matches the UID in the request. If no such record is found, the SPCC sends an UNAVAILABLE response to the requestor. If the record is found, then the SPCC retrieves from its R-DB the IP address and port number of the host computer of the invited user and sends an INVITE-ALERT message to the destination host. The INVITE-ALERT message includes the CID of the conference, the name and/or UID of the inviting user, supported conference media type, conference metadata, and may also include additional information related to the conference, e.g., the list of the current participants in the conference. If the SPCC cannot send the INVITE-ALERT message to the destination host, e.g., the host has crashed or is unreachable due to network failure, it sends an INVITE-FINAL-RESP response with the request status of UNREACHABLE to the INVITE requester.

If the destination address information in the INVITE request is the IP address/port number of a computer, any authorized user at that computer is invited to the conference. This is similar in concept to calling a telephone. The SPCC may authenticate the user from the security information contained in the subsequent messages from the CCC of the CLIENT at the host.

If the destination address information in the INVITE request is a phone number, the SPCC instructs the SPMS to call the number from within the context of the conference. The process is similar to adding a new conference participant who wishes to use audio (with 64 Kbps bandwidth requirement) as the means of communication, except that a VoIP/PSTN gateway is involved to connect to the PSTN. One method by which telephones can be used for audio communications in a conference is described later in this patent.

In one embodiment of the present invention, the invited user may have specified a-priori to use a telephone for conferences that involve audio communications. The telephone number may be stored in the R-DB of the SPCC as part of the user's preference record. In such a case, the SPCC may instruct the SPMS to call the number without first sending an INVITE-ALERT request to the CCC of the CLIENT of the invited user. Whether or not to send an INVITE-ALERT request may depend on the user's preference. If the request is sent, the JOIN request from the CCC of the CLIENT of the invited user dictates whether or not the telephone number in the R-DB is called. Specifically, the telephone number in the R-DB is called only if the JOIN request does not have an alternate telephone number.

Joining a Conference

When the CCC of the CLIENT of the invited user receives the INVITE-ALERT message, an INVITE-ALERT-RESP response is sent to the SPCC, acknowledging the receipt of the INVITE-ALERT message, and the user is alerted of the incoming invitation. In addition, the supported conference media type and any conference metadata in the INVITE-ALERT message may be displayed, and the user may select the media type(s) he wishes to use in the conference. If the user accepts the invitation and specifies the selected media types, then the CCC sends a JOIN request to the SPCC. This JOIN request includes the CID of the conference, the UID of the invited user, the UID of the inviting user, and the selected media types of the invited user if specified, and may include other appropriate or desired information. The selected media types are a list of media tuples. If the user wishes to use a telephone in the conference, then the JOIN request includes a telephone number in the form of a media tuple, e.g., (TEL, +1-555-123-4567, NULL), where TEL is the MEDIA value, and the telephone number is the CODEC value. The media tuple for the telephone number is included in the selected media types. Note that TEL is the same as the audio media type, except that it indicates to the system that a telephone number should be called. If the JOIN request does not include a telephone number, then the user is set up by default to use the Voice over IP (VoIP) facilities built in the underlying RTC platform.

If the user rejects the invitation, or if the CCC times out while waiting for the user to respond, the CCC sends a BUSY request to the SPCC. The BUSY request includes, but is not limited to, the CID of the conference, the UID of the invited user, and the UID of the inviting user.

Upon receiving the INVITE-ALERT-RESP response, the SPCC sends an INVITE-PROGRESS-RESP response to the CCC of the CLIENT of the user who sent the INVITE request. This response indicates that the invited user is processing the invitation and includes at least the CID of the conference and UID of the invited user.

Upon receiving the JOIN request, the SPCC notifies the SPMS that a new user is joining a conference. Specifically, it sends to the SPMS the CID of the conference, the UID of the joining user, and the selected media types of the joining user. In addition, the SPCC may instruct the SPMS to create and return a Server-side Media Address (SM-ADDR) for the new participant, which mainly provides the address information needed for the CSC of the participant CLIENT to establish a real-time session with the SPMS and to add (remove) media streams to (from) the session via the RTC platform API. In a preferred embodiment of the present invention, the SM-ADDR comprises the IP address and port number of the host computer, on which the SPMS is executing. The SM-ADDR may also include the media types, i.e., a list of media tuples, for which the real-time session to be established with the SPMS. The address information in the SM-ADDR does not specify the destination to which the CLIENT sends media payloads, but rather, specifies the host to which the CLIENT communicates signaling messages with the SPMS to establish a real-time session and manage media streams in the session. In a preferred embodiment of the present invention that uses the MS RTC, the address information for communicating media payloads is negotiated as part of the session establishment and stream management process.

In the case of multiple instances of the SPMS running on different host computers, the SPCC may first need to select a particular instance for the conference. The selection depends on the current load in the system, the locations of participant CLIENTs, and other variables. Furthermore, multiple instances of the SPMS may be used for the same conference, in which case, the multiple instances of the SPMS are collectively viewed as a single unit that is functionally equivalent to a single instance of the SPMS. For example, one of the SPMS instances plays the role of the master, and the others play the role of slaves. In addition, each master or slave SPMS instance is connected with one or more participant CLIENTs. In this architecture, a slave SPMS always routes the received media payloads to the master SPMS, which, in turn, sends them to all the slaves, each of which, in turn, sends them to their respective CLIENTs. The precise method used is dependent on the service provider.

In one embodiment of the present invention, once the CID of a conference, the UID of the new participant, and the selected media types of the new participant are known, the SPMS creates the corresponding SM-ADDR per participant, that is, each participant CLIENT in the conference is associated with its own SM-ADDR. In another embodiment of the present invention, the SPMS creates a SM-ADDR per conference, that is, all the participants in the conference share the same SM-ADDR. In both cases, the SPMS keeps track of the participant membership of the conference. In the per participant embodiment, the SPMS also keeps track of which SM-ADDRs belong to which participant CLIENTs.

To create an SM-ADDR for a new participant, the SPMS first checks if a conference database record exists for the given conference. If so, the SPMS retrieves the existing database record from its C-DB. If not, the SPMS creates a new conference database record and stores the CID of the conference in it. Subsequently, the SPMS allocates an available port number on its host computer and creates a new SM-ADDR that has the IP address of its host computer and the new port number. The new SM-ADDR may also include the list of the media types that the SPMS allows for the conference. This list may be only a subset of the selected media types specified in the JOIN request to the SPCC as some media types may not (or cannot) be supported by the system because of insufficient availability of network bandwidth or other resources and other reasons. If the selected media types in the JOIN request include a telephone number, and if the SPMS has enough resources or otherwise can call out the specified telephone number, the SM-ADDR may include the corresponding media tuple for the telephone number. Finally, the SPMS stores the tuple, (UID, SM-ADDR), in the conference database record, where UID is the UID of the participant, and SM-ADDR is the new SM-ADDR for the participant, and sends the new SM-ADDR to the SPCC along with the CID of the conference, and the UID of the participant.

The SPCC stores in its conference database record the SM-ADDR associated with the new participant and the UID of the new participant as a TENTATIVE member; a participant who is not yet communicating with the other participants in the conference. Once the participant starts communicating, the status changes to FULL. The SPCC also sends an INVITE-FINAL-RESP response to the CCC of the CLIENT of the user who sent the INVITE request. This response indicates that the invited user has accepted the invitation to join the conference and includes, the CID of the conference and UID of the invited user as well as other desired information. Subsequently, the SPCC sends a JOIN-OK response to the CCC of the CLIENT of the new participant, which response includes the CID of the conference and the SM-ADDR associated with the participant, as well as other appropriate or desired information. The TENATIVE member may be assigned a time-out period, during which the participant should start communicating. If the time-out period expires, the SPCC may additionally wait for a grace period after which the SPCC may remove the participant from the conference and then notify the SPMS.

When the SPCC receives a BUSY request from the CCC of the CLIENT of an invited user, the SPCC sends an INVITE-FINAL-RESP with the request status of UNAVAILABLE to the CCC of the CLIENT of the inviting user. Subsequently, the SPCC sends a BUSY-OK to the CCC of the CLIENT of the invited user, acknowledging the receipt of the BUSY request.

When the CCC of the CLIENT receives the JOIN-OK response from the SPCC, the user has tentatively joined the conference who's CID is included in the response. However, the user cannot yet communicate with the other participants in the conference because no communications channels have been established between the CSC of the user's CLIENT and the SPMS. The SM-ADDR in the JOIN-OK response enables the CSC to establish such communications channels. Specifically, the CCC retrieves the SM-ADDR from the JOIN-OK response and sends it to the CSC, which uses the address information in the SM-ADDR to establish a real-time session with the SPMS via the API of the underlying RTC platform as shown in FIG. 1. Then the CSC adds to the session a real-time communications stream for each media type in the SM-ADDR. Each stream enables the user to communicate with the other participants in the conference using a conference media type via the SPMS.

The exact manner in which the CSC establishes a session with the SPMS depends on the underlying RTC platform API. In a preferred embodiment of the present invention that uses the MS RTC platform, the session is established as follows. In describing the MS RTC platform, the method and object names are from the C++ version. If not already done, the CSC initializes the MS RTC platform by calling the Initialize( ) method on its RTCClient object and may also specify the media types to be used for new sessions by calling the SetPreferredMediaTypes( ) method on the RTCClient object. The available media types in the MS RTC platform are defined as RTCMT_Constants and include RTCMT_AUDIO_SEND, RTCMT_AUDIO_RECV, RTCMT_VIDEO_RECEIVE, RTCMT_VIDEO_SEND, and RTCMT_T120_SENDRECV. The CCC, CSC, SPCC, and SPMS may use a different mechanism to specify media types, in which case, the CSC should map its media types to those in the MS RTC platform when calling SetPreferredMeidaTypes( ) and other API method calls, e.g., AddStream( ), for which the CSC should specify media types as parameter values. The MS RTC platform negotiates the bandwidth and other QoS -related properties of real-time media types, i.e., audio and video, when establishing a session with the other end point; the SPMS in this case, using the Session Initiation Protocol (SIP) and Session Description Protocol (SDP).

To create the session with the SPMS using the MS RTC platform, the CSC calls CreateSession( ) on the RTCClient object. CreateSession( ) allows the MS RTC platform application to specify information about the session to be created and session creator. Among the parameter values passed in to this call is the session type. The MS RTC platform defines the RTC_SESSION_TYPE enumeration that includes RTCST_PC_TO_PC, RTCST_PC_TO_PHONE, RTCST_PHONE_TO_PHONE, and RTCST_IM, which is used to create an instant messaging session. The current implementation of the MS RTC platform allows multiple media types only in the sessions of type RTCST_PC_TO_PC. For the sessions of the other types, the MS RTC platform only allows audio communications. Therefore, if the conference is to be used for multimedia communications, the session between the CSC and SPMS needs to be of type RTCST_PC_TO_PC. Another parameter value passed in to CreateSession( ) is the address information of the session creator. If the user is not using a telephone, the address information is a SIP URL, e.g., SIP: jsmith@company. com, where jsmith@company. com is the UID of the user. If the user is using a telephone, the address information is a SIP URL, e.g., SIP:+15551234567@company.com;user=phone, or a TEL URL, e.g., TEL:+1-555-123-4567. In the latter case, the SPMS assumes the functionality of or instructs a PSTN gateway to call out to the specified number. One method by which the SPMS calls out to a telephone number in the context of a conference is described later in this patent. Because CreateSession( ) only takes a single address for the session creator, it is not feasible for the SPMS to verify that the user at the specified telephone number is an authenticated user with proper authorization. Rather the SPMS requires that the telephone number specified in CreateSession( ) should be the same as the one in the JOIN request sent to the SPCC when joining the conference and assumes that the user at the specified telephone number has the UID appearing in the JOIN request.

The successful completion of the CreateSession( ) call returns an RTCSession object to the CSC. Subsequently, the CSC calls AddParticipant( ) on the returned RTCSession object. The parameter values passed in to this call include the IP address and port number of the SPMS as specified in the default SM-ADDR. The successful completion of this call means that a real-time session has been established between the CSC and SPMS and that one or more streams have been added to the session, through which the participant can communicate with the other participants in the conference by sending and receiving conference media payloads of the default type via the SPMS. The types of the streams that are created at this time depend on both the preferred media types as specified in the RTCClient object and the media types supported by the SPMS as specified in the JOIN-OK response.

In order to join a conference, the CCC of the potential participant needs the CID of the conference. Typically, the CCC obtains the CID by either creating the conference or by being invited to the conference. However, the CCC may also obtain the CID by an external means, such as email or instant-messaging, and the user then instructs the CCC of the user's CLIENT to join the conference with the received CID. The CCC may then attempt to join the specified conference by sending a JOIN request to the SPCC. The processing of this JOIN request is identical to that of the JOIN request sent in response to an INVITE-ALERT message. In FIG. 1, the direct line between the CCC components of the two CLIENTs signifies such an external means of communication for conference management. In an embodiment of the present invention that may have multiple instances of the SPCC and that different CCCs of different users may be associated with different instances of the SPCC, the address information of the SPCC that has the conference database record may be passed along with the CID of the conference, which may be considered a security risk. In the preferred embodiment of the present invention, the multiple instances of the SPCC may share a conference database, in which case the address information need not be communicated.

When the CSC successfully establishes a session with the SPMS, the SPMS alerts the SPCC, which then updates the member status of the participant from TENATIVE to FULL. In addition, the SPCC notifies the current conference participants of the membership change by sending each of them a NOTIFY-CONF-MEMBERSHIP message. This message includes a list of (name, UID) tuples, where each tuple represents a participant, name is the name of the participant, and UID is the UID of the participant. The UID of the participant is used to initiate separate communications sessions by a subgroup of the conference participants. In addition, the CCC of the CLIENT of each participant user acknowledges the NOTIFY-CONF-MEMBERSHIP message by sending a NOTIFY-CONF-MEMBERSHIP-OK message to the SPCC. In another embodiment of the present invention, the NOTIFY-CONF-MEMBERSIP message may only contain the tuple for the participant whose participation changed. If the participant whose participation changed is a phone user, the UID is the participant's telephone number.

In another embodiment of the present invention, the SPCC performs the task of generating the SM-ADDR for new conference participants. When the SPCC receives the JOIN request, it creates an SM-ADDR that includes the IP address and port number of its host computer. In this case, the CSC of the new participant establishes the real-time session with the SPCC, which directs the CSC to send its media payloads to an appropriate SPMS by communicating the IP address and port number of the SPMS to the CSC while establishing and adding streams to the session.

Leaving a Conference

To leave a conference, the CCC of the participant CLIENT sends a LEAVE request to the SPCC. This request includes the CID of the conference and the UID of the participant. Upon receiving this request, the SPCC removes the UID and SM-ADDR entries from its conference database record and alerts the SPMS for the conference that the participant has left the conference. The SPMS then removes the UID and SM-ADDR entries from its conference data record and discontinues routing of media payloads from the CSC of the departing participant to the other participants or payloads from others to the participant who left. SPCC also notifies the current conference participants of the membership change by sending NOTIFY-CONF-MEMBERSHIP messages and sends a LEAVE-OK response to the CCC of the departing participant CLIENT.

Upon receiving the LEAVE-OK response, the CCC instructs the CSC to close the real-time session with the SPMS. In a preferred embodiment of the present invention that uses the MS RTC platform, the CSC closes the session by calling the Terminate( ) method on its RTCSession object. The successful completion of this call also results in the removal of any streams in the session. Once the session is closed, the CSC cannot communicate with the SPMS. In another embodiment of the present method, closing the session may be initiated by the SPMS when it receives an alert that the participant has left the conference. For the CSC built on the MS RTC platform, the SPMS may send a SIP BYE request to the IP address and port number of the host computer of the CSC, which was negotiated as part of the session establishment process. The BYE includes the same SIP CallID header as the one in the SIP INVITE-200 Ok-ACK transaction used for the session establishment between the MS RTC platform and SPMS.

Uninviting a Participant

It may be necessary to remove an existing participant from the ongoing conference, in which case, the CCC of the CLIENT of the conference administrator sends an UN-INVITE request to the SPCC. The UN-INVITE request includes the CID of the conference, the UID of the conference administrator, and the UID of the participant to be un-invited. The conference administrator is typically the creator of the conference, however, other participants may assume the role of conference administrator.

The processing of the UN-INVITE request by the SPCC and SPMS is similar to that of the LEAVE request. Both the SPCC and SPMS remove the UID and SM-ADDR entries from their respective conference records, and the SPCC notifies the other participants of the membership update. The main difference is that the SPCC sends an UN-INVITE-ALERT message to the CCC of the CLIENT of the participant to be un-invited. This message includes the CID of the conference and any other appropriate information. The participant cannot refuse to be uninvited, and upon receiving the UN-INVITE-ALERT message, the CCC instructs the CSC to close its session with the SPMS. In addition to sending the UN-INVITE-ALERT message, the SPCC sends a UN-INVITE-OK response to the CCC of the conference administrator who sent the UN-INVITE request.

Adding and Removing a Media Type

It is also possible to add or remove a media stream to or from an ongoing conference. To do so, the CCC of the participant CLIENT sends a CONF-ADD-STREAM request to the SPCC. This request includes the CID of the conference, the UID of the requestor, and the new conference media type. Upon receiving this request, the SPCC checks with the SPMS to determine whether or not to grant it, with the decision depending on many factors, such as, the current load on the SPCC and network condition. If not granted, the SPCC sends a CONF-ADD-STREAM-DENIED response to the original requestor. If granted, the SPCC sends a CONF-ADD-STREAM-OK response to the original requestor and a CONF-ADD-STREAM-ALERT request to the CCCs of the other participants. Both CONF-ADD-STREAM-OK and CONF-ADD-STREAM-ALERT include the CID of the conference, the UID of the original requester, and the new conference media type. In both cases, the CCC alerts the CSC to add the new conference media stream to the specified conference. In the latter case, the CCC also sends a CONF-ADD-STREAM-ALERT-RESP response to the SPCC.

When other conference participants receive a CONF-ADD-STREAM-ALERT, they may decide to add the stream or not. If the stream is to be added, their CCC alerts their CSC to add the stream. In all cases a CONF-ADD-STREAM-ALERT-RESP is sent to the SPCC. This message includes the CID of the conference, the new conference media type, and a status of: OK if the stream will be added, UNAVAILABLE if the stream can not be supported, or BUSY if the participant does not wish to add that stream.

The process of removing an existing media stream from an ongoing conference is similar to that of adding a new media stream to an ongoing conference. The CONF-REMOVE-MEDIA-STREAM and CONF-REMOVE-MEDIA-ALERT requests are used. The only time a CONF-REMOVE-MEDIA-STREAM request is denied is if the request specifies a conference media type that is not in use, in which case the SPCC sends a CONF-REMOVE-MEDIA-STREAM-ERROR response to the original requestor. Otherwise, the SPCC sends a CONF-REMOVE-STREAM-OK response to the original requester and a CONF-REMOVE-STREAM-ALERT request to the CCCs of the other participant CLIENTs who are using that stream. In both cases, the CCC alerts the CSC to remove a conference media stream from the specified conference. In the latter case, the CCC also sends a CONF-REMOVE-STREAM-ALERT-OK response to the SPCC.

The process will be further described with reference to the MS RTC platform. To add a new stream to an ongoing conference, the CSC calls AddStream( ) on the RTCSession object that represents a session that has been established between the CSC and the SPMS for the conference. Among the parameter values passed in to this call is the desired media type, but no address information is passed in to this call. The successful completion of this call means that the participant may send and receive the media payloads of the new type to and from the other participants via the SPMS. Similarly, to remove an existing stream of a particular media type from an ongoing conference, the CSC calls RemoveStream( ) on the RTCSession object that represents a session that has been established between the CSC and the SPMS for the conference. Among the parameter values passed in to this call is the media type to be removed. The successful completion of this call means that the participant can no longer communicate with the other participants via the SPMS using the removed media.

The CSC may call AddStream( ) or RemoveStream( ) independently of CONF-ADD-STREAM and CONF-REMOVE-STREAM, in which case, the action affects only the session between the CSC and SPMS, and not the entire conference. In other words, the other participants may continue to use this media type to communicate among themselves.

As described earlier, the IP address and port number of the host to which the CSC sends media payloads are negotiated while the session with the SPMS is established and when a new stream is added to the session. This address negotiation is automatically performed by the underlying RTC platform. In a preferred embodiment of the present method that uses the MS RTC platform, the processes of establishing and adding new streams to the session use the Session Initiation Protocol (SIP). Thus in order to interoperate with the CSC built on the MS RTC platform, the SPMS should be able to process SIP requests and responses. In a preferred embodiment of the present invention, the Microsoft Real-time Communications Server platform (not to be confused with the Microsoft Real-time Communications Client platform which has been the primary focus of this discussion), which supports the SIP, may be used to implement the SPMS for the maximum level of interoperability.

Further, various protocols are used by RTC platforms to send and receive media payloads. For example, the MS RTC platform uses Real Time Protocol and Real Time Control Protocol (RTP/RTCP) to send and receive audio and video media payloads. In all cases, the SPMS should be able to send and receive the protocol packets required for operation. For example, is using the MS RTC platform, the SPMS should accept RTP/RTCP packets.

The described method and system enables not only conferences for real-time communications, e.g., audio and video, but also conferences for non real-time communications, e.g., multi-party text instant messaging and T.120-based collaborations. The functionalities and operations of the CCC, CSC, SPCC, and SPMS for creating and managing conferences for non real-time communications are the same as for creating and managing conferences for real-time communications. In both types of conferences, the SPMS sends and receives the communications payloads of the media type(s) chosen by conference participants. On the client side, communications devices should be available that the CSC can use to generate and render the communications payloads of the media payloads used in conferences. In a preferred embodiment of the present invention, the CLIENT may have multiple instances of the CSC, one for each conference that the user wishes to participate in. As noted above, when using the MS RTC platform, the CLIENT is restricted to only one CSC for a conference for real-time communications at a time because of the limitation that the MS RTC platform supports only a single real-time session at a time. In another embodiment of the present invention, a single CSC may manage all the sessions, each of which is established with the SPMS for a conference that the user participates in.

Using a Telephone in a Conference

As described earlier, telephones may be used for audio communications in a conference. An INVITE request may specify a telephone number as the address information of the invited user. An INVITE request may also specify the UID of a user whose preference is to receive a telephone call without first being alerted of the invitation via the CCC of the CLIENT of the user. Finally, the SM-ADDR in a JOIN-OK response includes a media tuple for a telephone number, which has been included as a selected media type in a JOIN request. In the first two cases, the SPCC instructs the SPMS to call the telephone number. In the third case, the SPMS calls the telephone number when the real-time session is established between it and the CSC of the participant. In the preferred embodiment of the present invention that uses the MS RTC platform, the SPMS calls the telephone number specified in the SIP From header of the SIP INVITE request that it receives at the session establishment time.

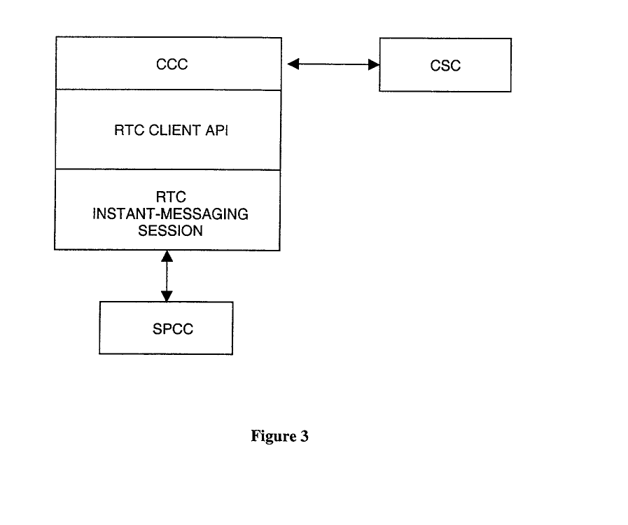

The method by which the SPMS calls a telephone number and allows the telephone user to participate in a conference is the same in all cases. FIG. 3 shows the architecture of one such method. VoIP-PSTN GATEWAY refers to any commercially available hardware or software module that interconnects a Voice over IP network (VoIP) and the telephone network (PSTN). On the VoIP side, the VoIP-PSTN GATEWAY typically supports a session management protocol, e.g., SIP and H.323, and media packet transmission and control protocols, e.g., RTP and RTCP. On the telephone network side, it has network connections and other facilities needed to interface with the PSTN. The VoIP-PSTN GATEWAY may also include a hardware/software component, commonly known as a TRANSCODER in the art, which dynamically changes the encoding algorithms of audio payloads when they are transmitted from the VoIP network to the PSTN and vice versa. The method by which the VoIP-PSTN GATEWAY provides its functionality is well known in the art.

In FIG. 3, the key architectural component that allows the telephone user to participate in a multiparty conference is the PSTN PROXY. In general, telephones cannot mix multiple incoming audio streams and are not suited for use in multiparty conversations. Thus the PSTN PROXY provides the MIXER, which performs the mixing operations on behalf of telephones. Specifically, in a given period of time, the MIXER receives RTP packets from the SPMS and performs the following tasks in sequence: 1) extract the audio payloads from the RTP packets, 2) decode the payloads to produce analog signals, 3) mix the signals into a single signal, 4) encode the mixed signal to produce a sequence of digitized payloads, and 5) include each payload into a RTP packet and send the packet to the VoIP-PSTN GATEWAY. As will be described shortly, the RTP packets contain audio payloads that are communicated within the same conference. The method by which each of the above tasks is performed is well known in the art.

In addition to the MIXER, the PSTN PROXY contains the ROUTER, which receives the RTP packets from the VoIP-PSTN GATEWAY and sends them to the SPMS. The payloads in the RTP packets represent the audio input of the telephone user who is a conference participant.

Before the MIXER can perform its tasks, it should know the address of the VoIP-PSTN GATEWAY, i.e., its IP address and port number to which to send its RTP packets. In addition, the VoIP-PSTN GATEWAY should know the telephone number to call and the address of the ROUTER, i.e., the IP address and port number of the host computer of the PSTN PROXY, in order to sends the RTP packets from the telephone user. Furthermore, the TRANSCODER in the VoIP-PSTN GATEWAY should know the audio codec(s) used for the conference on the VoIP network.

It is the function of the SESSION MANAGER in the PSTN PROXY, in conjunction with the SPMS, to determine these and other session information for the MIXER, ROUTER, and VoIP-PSTN GATEWAY. In the following, we describe in detail the process by which the session information is established and distributed. When calling a telephone number for a conference, the SPMS allocates a port number on its host computer to which the ROUTER can send its RTP packets and sends a CALL request to the SM in the PSTN PROXY. The CALL request may include, but is not limited to, the CID of the conference, the telephone number, and the IP address and allocated port number. In the preferred embodiment of the present invention that may include multiple instances of the PSTN PROXY, the SPMS may dynamically select a particular instance based on the telephone number to call.

Upon receiving the CALL request, the SM in the PSTN PROXY negotiates with the VoIP-PSTN GATEWAY the address information needed for its MIXER and the gateway. The exact method by which the address information is negotiated may depend on the session management interface supported by the gateway. In the preferred embodiment of the present invention, in which both the SM in the PSTN PROXY and VoIP-PSTN support SIP, the address information negotiation is the same as making a phone call from an SIP User Agent, e.g., a SIP phone. That is, the SM retrieves the telephone number from the CALL request and instructs the VoIP-PSTN GATEWAY to call the number via the usual SIP INVITE-200 Ok-ACK transaction. Specifically, the SM allocates a port number at which the ROUTER may receive the RTP packets from the gateway and creates and sends a SIP INVITE request that has the IP address of the host computer of the PSTN PROXY and the allocated port number in its SDP message body. The 200 Ok response from the VoIP-PSTN GATEWAY, which signals that the user has answered the telephone, includes the address information to be used by the MIXER to send its RTP packets. If the embodiment includes multiple instances of the VoIP-PSTN GATEWAY, the SM may dynamically select a particular instance to use based on the telephone number to call.

Subsequently, the SM in the PSTN PROXY allocates a port number at which the MIXER may receive RTP packets from the SPMS and sends a CALL-OK response to the SPMS. This response may include, but is not limited to the CID of the conference, the telephone number, and the IP address of the host computer of the MIXER and allocated port number.

If the attempt to call the telephone number fails, e.g., the user does not answer the call, the SM sends a CALL-BUSY response to the SPMS, when notified by the VoIP-PSTN GATEWAY. In turn, the SPMS alerts the SPCC of the failure. Subsequently, the SPCC notifies the user, who invited the telephone user, of the failure by sending an INVITE-FINAL-RESP response with the request status of BUSY. In cases where the SPMS tries to call the telephone number as part of establishing a real-time session with the CSC of the participant, and the real-time session is not established, the CSC receives an error or failure notification from the underlying RTC.

When the telephone user hangs up the phone, the VoIP-PSTN GATEWAY alerts the SM of the PSTN PROXY, which in turn releases resources used by the MIXER and ROUTER and then sends a NOTIFY-HANG-UP request to the SPMS. This request may include, but is not limited to, the CID of the conference and the telephone number. Upon receiving this request, the SPMS updates its conference database record and sends back a NOTIFY-HANG-UP-OK response to the SM of the SPMS. In addition, the SPMS may relay the NOTIFY-HANG-UP request to the SPCC, which in turn, alerts the conference participants of the membership change as described earlier in this patent.

When the CCC of the participant using a telephone sends a LEAVE request, the processing of which has been described earlier in this patent, the SPMS sends a HANG-UP request to the SM of the PSTN PROXY. This request includes, but is not limited to, the CID of the conference and telephone number. In turn, the SM of the PSTN PROXY instructs the VoIP-PSTN GATEWAY to hang up the telephone and sends a HANG-UP-OK to the SPMS.

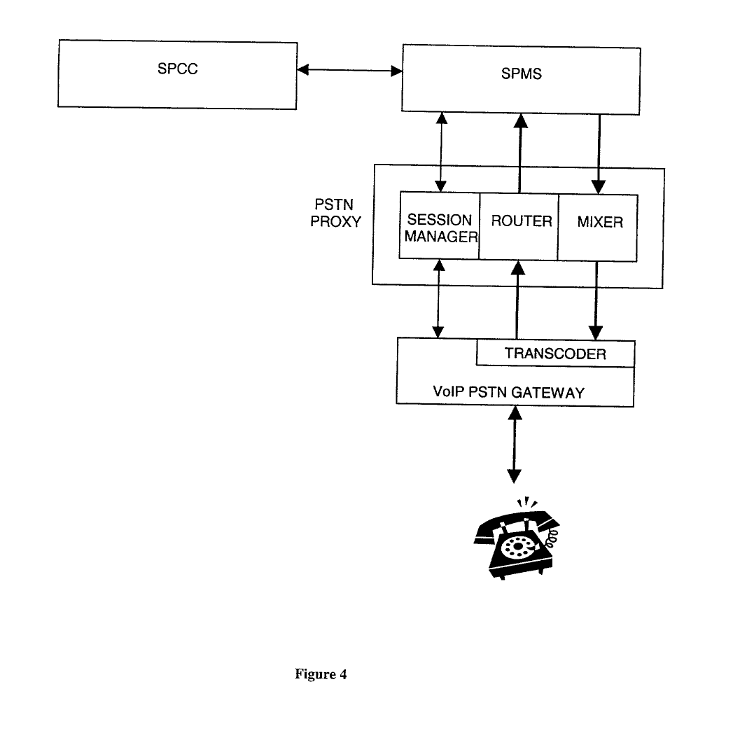

The conference management functionalities that have been described are generic to any particular implementation platform or technologies. In fact, the manner in which these conference management functionalities are provided depends on the desired level of ease of use, availability, and accessibility of the service for end users. In a preferred embodiment of the present invention, the built-in capabilities of the MS RTC platform are used to the extent possible. For example, in FIG. 4, the CCC of the CLIENT is implemented with a text instant messaging session on the MS RTC platform. The process of creating an instant messaging session is similar to that of creating a real-time session with the SPMS. The CCC needs the address information of the SPCC, which may be acquired when the user registers with the system. Subsequently, the CCC creates an instant messaging session with the SPCC by calling in sequence CreateConference( ) with RTCST_IM as the session type parameter value and AddParticipant( ) with the address information of the SPCC. We refer to this instant messaging session with the SPCC as the Conference Control (CC) session.

In the CC session, the CCC may exchange text instant messages with the SPCC for conference management purposes. For example, the CCC may send the string, “CREATE UID=jsmith@company. com MEDIA=audio,” as an instant message to the SPCC, which then parses this string to find that the specified user wishes to create a conference for audio communications. XML and related technologies may be used to define and verify the syntax and semantics of the text instant messages to be used in the CC session.

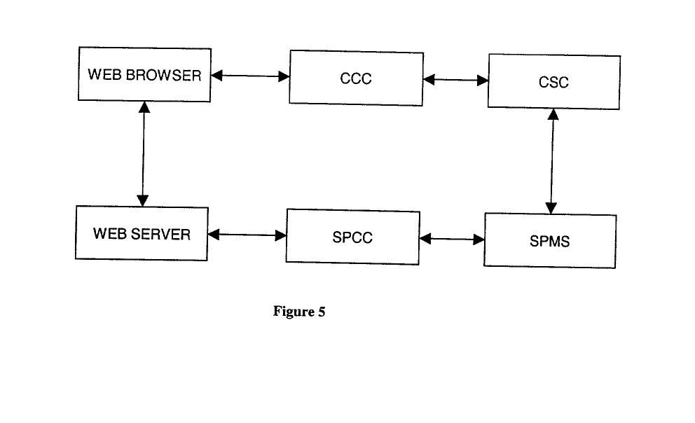

FIG. 5 shows how the existing Web and related technologies may be used to realize the conference management functionalities of the CCC and SPCC of the present invention. Specifically, the service provider maintains one or more Web servers, at which users may register and manage their conferences using their Web Browser applications. In a first embodiment of this approach, the CCC uses the Microsoft Internet Explorer browser application as a COM object. This way, the CCC controls the behavior of and captures the output data from the browser application. For example, when the user wishes to create a conference, the CCC sends to the browser application the URL of an appropriate Web page, at which point, the browser application downloads and displays the specified Web page. On the server side, a variety of Web-based technologies, e.g., CGI scripting, JSP, and ASP, may be used to deliver users' conference management requests to the SPCC and return any responses from the SPCC to the users.

The Web-based approach shown in FIG. 4 requires that the CCC and CSC components be preinstalled on the host computer. This requirement may limit user mobility. Therefore, in another embodiment of the Web-based approach as shown in FIG. 5, the CCC and CSC components are dynamically downloaded and installed on the host computer when the user accesses the Web pages of the conference service provider using a Web browser application. This way, only the RTC platform needs to be pre-installed on the host computer. The downloaded CCC and CSC are dynamically executed on the RTC platform on the host computer. The downloaded CCC still controls and interacts with the Web browser application via COM interfaces.

The “fat client” of FIG. 4, is well suited for providing a rich user experience, while the “Webbased” approach in FIG. 5 provides the effective means of supporting user mobility. The present invention also contemplates that the service provider may support both approaches at the same time. That is, one CCC may perform the conference management tasks through the CC session with the SPCC, while at the same time, another CCC may perform these tasks via the Web servers connected to the SPCC. Such an integrated approach dramatically increases the availability, accessibility, and user mobility support of the system. In addition the “Web-based” approach in FIG. 5 may also use the emerging Web Services technologies, which means that instead of sending and receiving HTML-formatted Web-pages, the Web browser application and the Web server communicate by exchanging SOAP requests and responses, which are XML documents that encode remote object method calls and return values respectively. In both cases, HTTP may be used as the main transport mechanism.

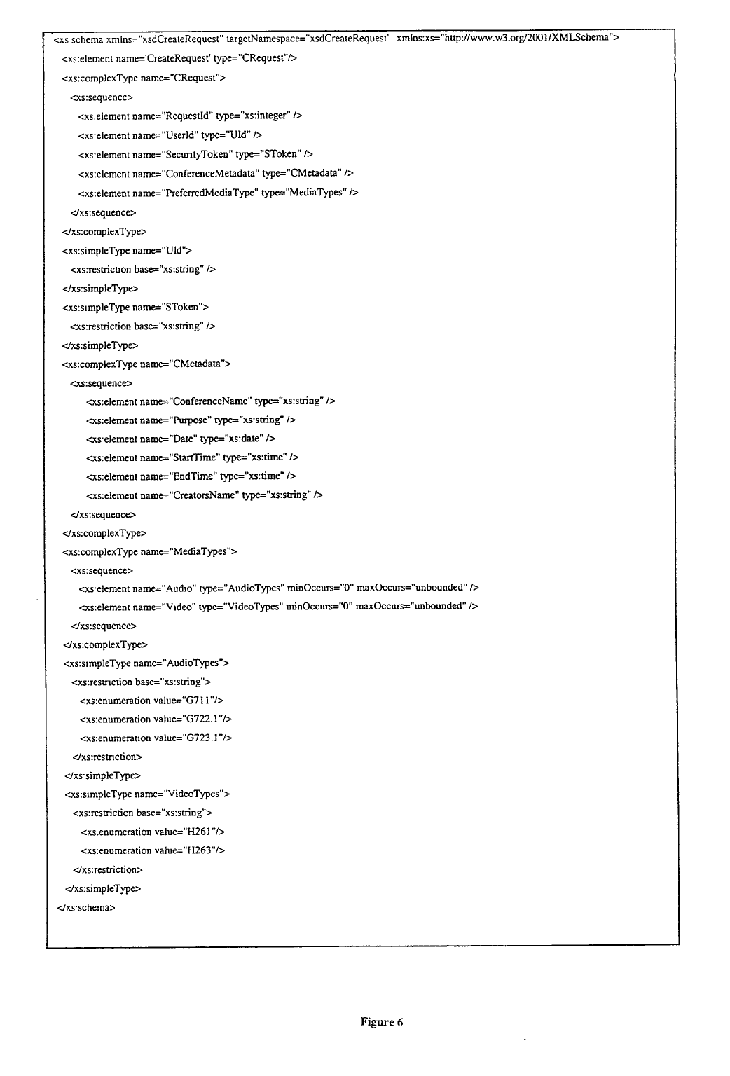

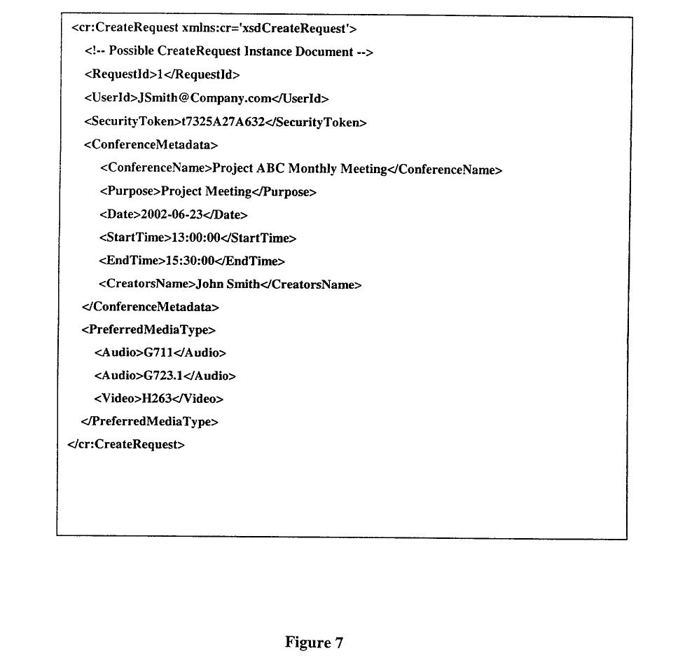

FIG. 6 illustrates one embodiment of an XML schema which may be used to validate CREATE requests. FIG. 7 illustrates a possible “instance document” view of the XML for the CREATE request based on the schema in FIG. 6. Other messages would be formatted similarly based on the message content described previously for each message type.

A particular advantage of the Web Service approach is that once the SOAP requests and responses are defined for conference management, different forms of client applications can easily be supported. The latest versions of current Web browser applications have built-in support for SOAP and XML. In addition, a “fat client” can be developed that can process the defined SOAP requests and responses. The on-screen presentation of the SOAP message exchange for the end user may be application-dependent. For example, the instant messaging paradigm, shown in FIG. 4, can be used as the means for the end user to interact with the CCC. When the user enters an instant message to be used for conference management, e.g., “CREATE UID=jsmith@company.com MEDIA=audio,” the CCC transforms the message into a SOAP request, which is then sent to the SPCC. Upon receiving a SOAP request or response from the SPCC, the CCC transforms it into a text instant message, which is then displayed on screen.

Depending on the communications contexts, the level of sensitivity of materials being discussed, and other factors, it may be required to secure conferences. This may involve both securing the exchange of protocol messages for conference management and securing the media payloads of the communications in a conference. A variety of methods exist to provide security in both cases. For example, Transport Layer Security (TLS) or Secure Socket Layer (SSL) connections may be established between two end points to ensure security of conference management functions. Then all the protocol messages are protected by the security services of the TLS/SSL connections. To protect the media payloads, the underlying RTC platform may provide security features that encrypt and decrypt communications payloads. For example, in the MS RTC platform, the put_EncryptionKey( ) method on the RTCSession object that represents a real-time session between the CSC and SPMS may be used to specify an encryption key to be used to protect the session media streams. Then MS RTC platform automatically encrypts and decrypts the media payloads in the session. If the SPMS is implemented as a mixer, then it should know the encryption key and crypto algorithm(s) used in the MS RTC platform in order to decrypt encrypted incoming media streams, mix plain media streams, and then encrypt mixed streams. In the preferred embodiment of the present method, the SPMS simply routes encrypted media streams and leaves the decryption and mixing tasks to the MS RTC platform, which has built-in capabilities to do so.

The present invention is not limited to the specific details described above, but rather includes variations, modifications and other implementations which would be recognized by those skilled in the art. Such variations, modifications and other implementations are included within the scope of the invention as set out in the following claims.

What is claimed is:

1. A system for providing multimedia, real time or non-real time conferencing services comprising:
a real-time communications platform, wherein said platform includes
basic support functionality for establishing communications between at least two end points, and
an application programming interface for enabling the addition of other applications and services;
an application which interfaces with said platform through said application programming interface; and
means for enabling multimedia, real time or non-real time conferencing services.

2. A system according to claim 1, wherein said application comprises:
a client conference controller for sending and receiving commands related to establishing and managing a conference; and
a client session controller for sending and receiving commands related to establishing and managing a session for a conference;
wherein said client session controller interfaces with said platform through said application programming interface.

3. A system according to claim 2, wherein said means for enabling conferencing services comprises:
a service provider conference controller for sending and receiving commands related to establishing and managing a conference, and communicating with said client conference controller; and
a service provider media server for sending and receiving commands related to establishing and managing a session for a conference, and communicating with said client session controller.

4. A system according to claim 3, wherein said provider conference controller includes
a registration database for storing information about authorized system users; and
a conference database for storing information about conferences.

5. A system according to claim 4, wherein said registration database stores user addresses.

6. A system according to claim 4, wherein said registration database stores user preferences.

7. A system according to claim 3, wherein said provider media server includes
a conference database for storing information about conferences.

8. A system according to claim 2, wherein said client conference controller and said client session controller are separate software modules which communicate with each other.

9. A system according to claim 2, wherein said client conference controller and said client session controller are included in a single software module.

10. A system according to claim 3, wherein said service provider conference controller and said service provider media server are separate modules which communicate with each other.

11. A system according to claim 3, wherein said service provider conference controller and said service provider media server are included in a single module.

12. A system according to claim 3, wherein said service provider conference controller and said service provider media server are located at the same or different service provider sites.

13. A system according to claim 3, wherein said access to said service provider conference controller and said service provider media server are provided using a web page.

14. A system according to claim 3, wherein said client conference controller and said client session controller are dynamically downloaded from a web page.

15. A system according to claim 3, wherein said client conference controller and said client session controller communicate with said service provider conference controller as a web service.

16. A system according to claim 2, wherein said client session controller supports mixing of media streams.

17. A system according to claim 3, wherein said service provider media server supports mixing of media streams.

18. A system according to claim 2, wherein one client session contoller exists for each conference.

19. A system according to claim 2, wherein a single client session contoller exists for multiple conferences.

20. A system according to claim 1, wherein said system supports one or more simultaneous non-real time sessions for a conference.

21. A system according to claim 1, wherein said system supports one or more simultaneous real time sessions for a conference.

22. A system according to claim 1, wherein said system supports one or more simultaneous non-real time sessions and one or more simultaneous real time sessions for a conference.

23. A system according to claim 1, wherein said system supports dynamically adding or removing a participant during a conference.

24. A system according to claim 1, wherein said system supports dynamically adding or removeing a media stream during a conference.

25. A system according to claim 3, wherein said commands are sent by means within said system.

26. A system according to claim 3, wherein said commands are sent by means external to said system.

27. A system according to claim 3, wherein said commands are sent using instant messaging protocol.

28. A system according to claim 3, wherein said commands are sent using XML.

29. A system according to claim 1, wherein said system further includes means to provide security for a conference.

30. A system according to claim 1, wherein said system supports the Real Time Protocol.

31. A system according to claim 1, wherein said system supports the Real Time Control Protocol.

32. A system according to claim 1, wherein said system supports the Session Initiation Protocol.

33. A system according to claim 1, wherein said system supports mixing of media streams.

34. A system according to claim 1, wherein said system supports the use of external communications devices.

35. A system according to claim 34, wherein said communications device is a telephone.

36. A system according to claim 1, wherein said system supports connection to the PSTN.

37. A system according to claim 1, wherein said platform is the Microsoft Real-time Communications Client platform.

38. A method of providing multimedia, real-time conferencing services on a real-time communications platform, wherein said platform includes
basic support functionality for establishing communications between at least two end points, and
an application programming interface for enabling the addition of other applications and services;
said method comprising:
establishing an application which interfaces with said platform through said application programming interface, said application including
a client conference controller for sending and receiving commands related to establishing and managing a conference; and
a client session controller for sending and receiving commands related to establishing and managing a session within a conference;
wherein said client session controller interfaces with said platform through said application programming interface; and
providing services enabling multimedia, real-time conferencing services.
